(19) United States
(12) Patent Application Publication
(10) Pub. No.: US 2007/0144576 A1
(43) Pub. Date: Jun. 28, 2007

(54) Photovoltaic module and use

(76) Inventors: Geoffrey Jude Crabtree, Vancouver, WA (US); Gilbert Duran, Chatsworth, CA (US); Christian Victor Fredric, Ventura, CA (US); Theresa Louise Jester, Carpinteria, CA (US); Douglas James Christopher King, Simi Valley, CA (US); Jeffrey Andrew Nickerson, Moorpark, CA (US); Paul Ray Norum, Camarillo, CA (US)

Correspondence Address: MCGLEW & TUTTLE, PC, P.O. BOX 9227, SCARBOROUGH STATION, SCARBOROUGH, NY, 10510-9227, US

(21) Appl. No.: 11/315,448

(22) Filed: Dec. 22, 2005

(51) Int. Cl. H02N 6/00

(52) U.S. Cl. 136/251

(57) ABSTRACT

A photovoltaic module comprising one or more photovoltaic cells packaged between a light-facing layer and a backside layer, wherein the light-facing layer comprises antimony-doped glass.

In one aspect, the present invention relates to a photovoltaic module.

Degradation of photovoltaic modules, for instance under the influence of their operation in light (so-called light-induced degradation or LID), is obviously an undesired phenomenon. There is thus a continuing need for reducing degradation of photovoltaic modules.

In one aspect of the invention, there is provided a photovoltaic module comprising one or more photovoltaic cells packaged between a light-facing layer and a backside layer, wherein the light-facing layer comprises antimony-doped glass.

In another aspect, the invention relates to a new use of antimony-doped glass. In accordance with this aspect of the invention, there is provided use of an antimony doped glass layer covering one or more photovoltaic cells in a photovoltaic module to reduce light-induced degradation of the photovoltaic module.

The antimony-doped glass is preferably substantially free of cerium.

The invention will be described hereinafter in more detail by way of example and with reference to the accompanying drawings, in which

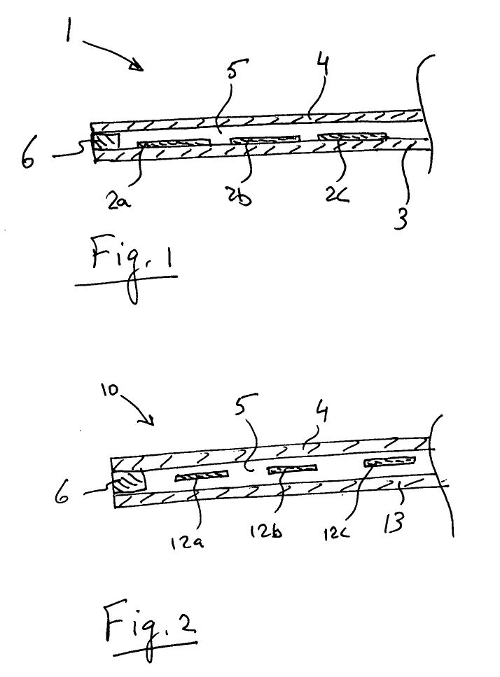

FIG. 1 schematically shows a cross section of a photovoltaic module;

FIG. 2 schematically shows a cross section of another photovoltaic module;

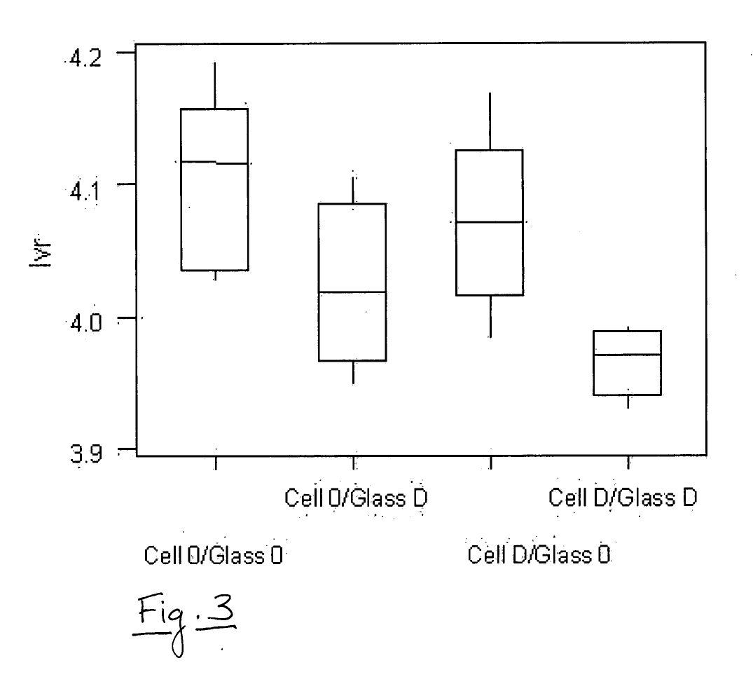

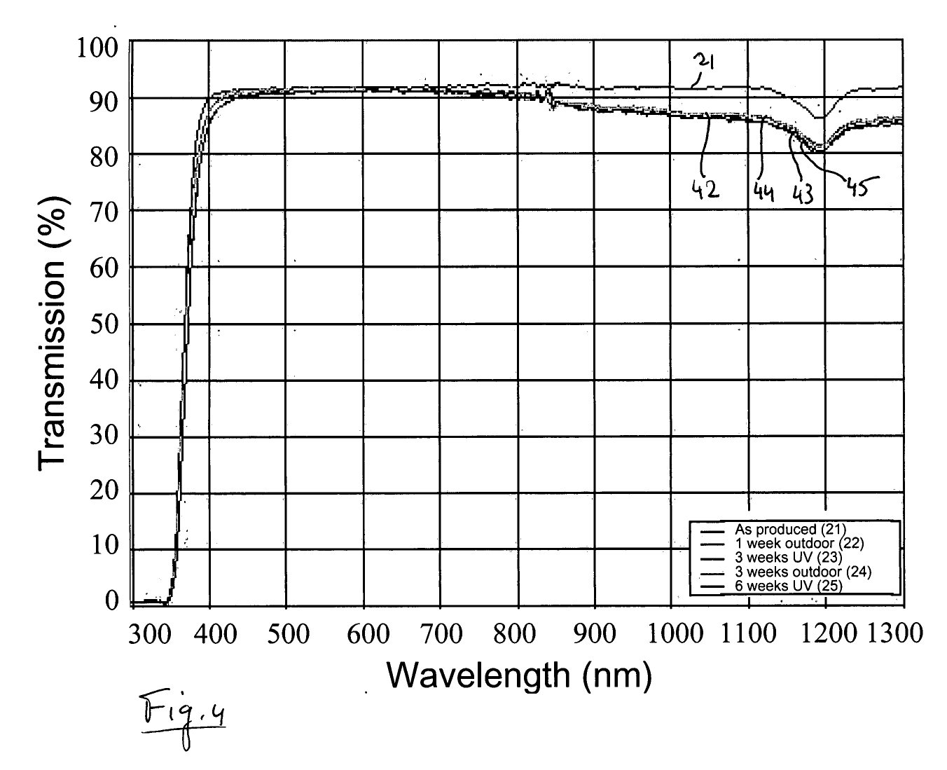

FIG. 3 shows a chart summarizing performance of photovoltaic modules;

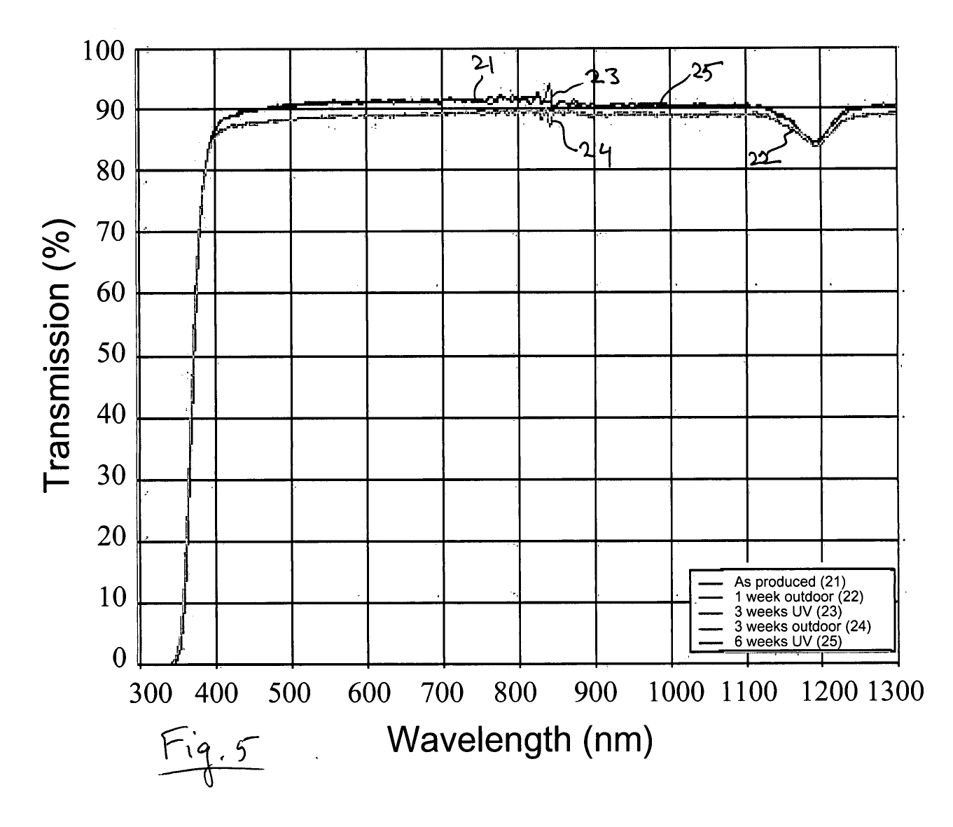

FIG. 4 shows transmission spectra of a laminate made of standard cerium doped glass combined with a standard EVA formula;

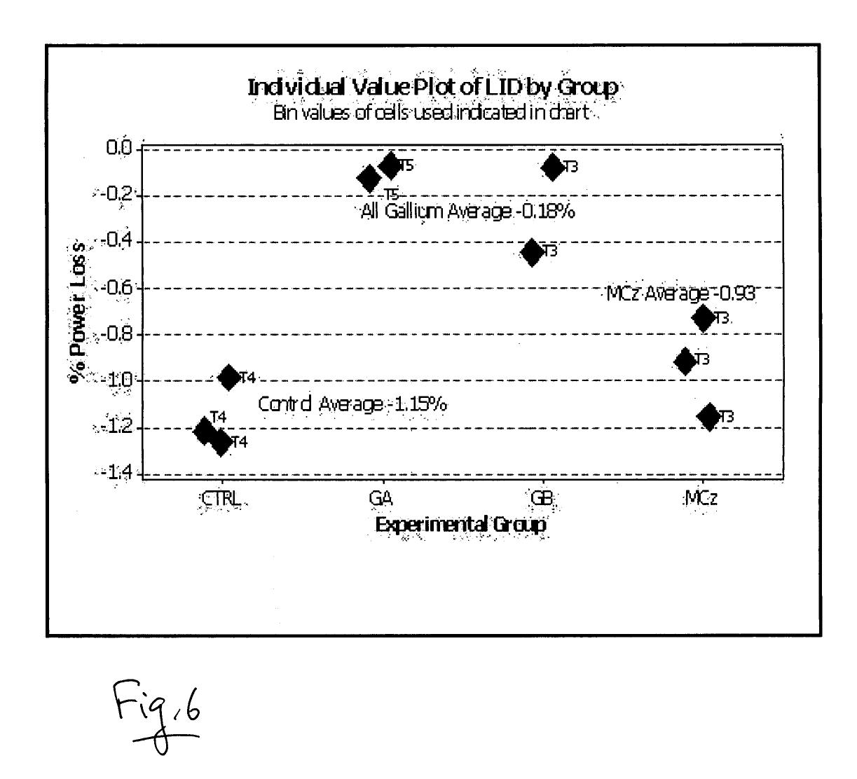

FIG. 5 shows transmission spectra of a laminate made with antimony doped glass combined with an improved EVA formula;

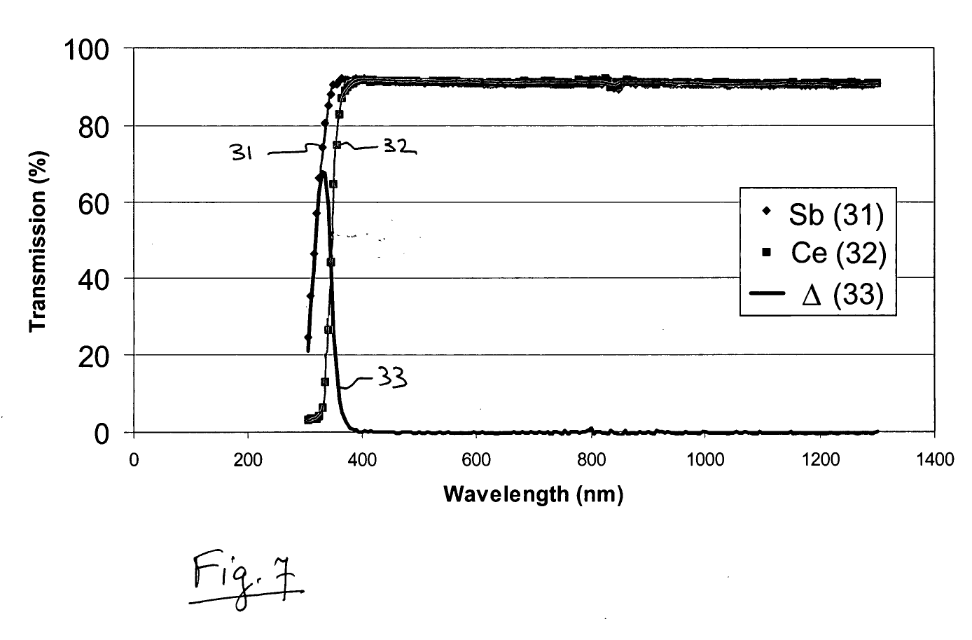

FIG. 6 shows a graphic representation of percentage power loss for various tested modules; and

FIG. 7 shows a comparison between transmission spectra of standard cerium doped glass and antimony doped glass.

In the Figures like reference numerals relate to like components.

Referring to FIG. 1 there is shown a schematic cross section of a part of a photovoltaic module 1 that forms an embodiment of the invention. The photovoltaic module 1 comprises one or more photovoltaic cells 2a, 2b, 2c packaged between a backside layer 3 and a light-facing layer 4.

In an embodiment, the space 5 extending between the backside layer and the light-facing layer may be filled with a transparent.

Typically, the transparent compound is located between the one or more photovoltaic cells and the light-facing layer. Optionally, the transparent compound may also be located between the one or more photovoltaic cells and the backside layer.

Optionally, an edge seal is provided at or near a periphery of the package. The edge seal may preferably comprise a moisture repellent material and/or a dessicant. Examples of suitable edge seal materials include butyl rubber, urethane and polyurethane materials, polyisobutylene materials, epoxide materials, polysulfamide materials; and cyanoacrylates. Such edge sealants may be applied in the form of a tape or strip prior to bringing the backside layer and the light-facing layer together.

The transparent compound suitably comprises an ethylene vinyl acetate (EVA). The EVA may be improved by adding ultra-violet radiation resistant chemicals that inhibit coloration (browning) of the EVA when placed outside for an extended period of time, up to 30 years, and employing fast-cure peroxides. This results in a transmittance of at least 91% over a spectrum comprising wavelengths ranging from 400 nm to 1100 nm in an 18 mil (0.46 mm) thick sheet after curing, and a UV cut-off wavelength of 360 nm.

Applicants purchased an embodiment of the improved EVA from Specialized Technology Resources Inc. (STR), 10 Water Street, Enfield, Conn. 06082, USA, under model number 15420 P/UF.

The backside layer of the photovoltaic module may be formed of a polymer material, typically a composite comprising a fluoropolymer to facilitate a long outdoor lifetime and a polyester to facilitate electrical isolation of photovoltaic circuitry packaged inside the module.

The light-facing layer is formed of an antimony-doped glass. The antimony-doped glass may be a soda-lime silicate glass, which is preferably substantially free of iron. The glass may be a so-called water white glass. It is preferably in the form of tempered float glass. In an embodiment, the glass exhibits a minimum of 90% (preferably a minimum of 91%) transmittance when measured over the spectral range from 350 nm to 2500 nm under Method A of ASTM-E424 and spectral distribution of ASTM-E892.

The glass may be tempered, preferably in compliance with ASTM C-1048.

Applicants purchased embodiments of the antimony-doped glass layer from AFG Industries Inc., 1400 Lincoln Street, Kingsport, Tenn. 37660, USA, under the name Solite 2000®.

The photovoltaic cells may be of any type, including those based on thin film technology and including those based on bulk-semiconductor technology.

The components as mentioned above may be laminated together to form a laminate.

Referring now to FIG. 2, there is shown a schematic cross section of a part of another photovoltaic module 10, forming another embodiment of the invention. The photovoltaic module 10 comprises one or more photovoltaic cells 12a, 12b, 12c packaged between a backside layer 13 and a light-facing layer 4.

In the case of the photovoltaic module 10 of FIG. 2, a transparent compound may be located on both sides of the one or more photovoltaic cells 12a, 12b, 12c, thus between the photovoltaic cells 12a, 12b, 12c and the light-facing layer 4 and between the photovoltaic cells 12a, 12b, 12c and the backside layer 13.

FIG. 3 shows the performance of boron-doped Czochralski-grown silicon photovoltaic cells (“Cz cells”) and light-facing layers in the form of cerium-doped module cover glass, both as produced (denoted as type 0), and degraded (denoted as type D). The doping level resulted in 1.1 Ωcm resistivity. Cell performance is given in terms of test current generated under a standard test illumination. From left to right, non-degraded cells and glass (Cell 0/Glass 0) averaged 4.12 Amps of test cell current. The non-degraded cells with degraded glass (Cell 0/Glass D) showed a 4.03 Amp test current. Degraded cells with non-degraded glass (Cell D/Glass 0) showed 4.08 Amps test current, and degraded cells covered with degraded glass (Cell D/Glass D) showed 3.96 Amps test current. This illustrates that not only the cell but also the glass contributes to the ultimate decayed value of approximately 96% of the initial value. It also shows that the contribution of the cover glass to the degradation was of the same magnitude as that of the cell.

FIG. 4 shows transmission spectra of a laminate made of standard (cerium-doped) glass (3-mm thick) combined with a 18-mil (0.45 mm) thick sheet of standard EVA formula. Over an exposure period (outdoors and UV exposure, respectively) of three weeks and six weeks, transmission measurements were made to quantify the changes experienced in the glass/EVA package. As can be seen by the graph, there is a measurable amount of transmission loss in the glass as exposed.

In contrast, FIG. 5 shows transmission spectra of a laminate made with antimony-doped glass combined with a 18-mil (0.45 mm thick) sheet of the improved EVA formula. This combination shows virtually no decay characteristics in the same exposure as the laminate described above with reference to FIG. 4.

Photovoltaic modules were produced employing photovoltaic cells in the form of various types of Czochralski grown silicon packaged under a light-receiving layer in the form an antimony doped cover glass and an improved EVA. A control group of cells was produced on the basis of boron-doped p-type Czochralski grown ingots having a resistivity of 1.1 Ωcm. Two other ingot types were tested in addition: Gallium doped ingots wherein the boron doping was replaced by Ga resulting in an average resistivity of 1.3 Ωcm, and boron-doped Magnetic-field-applied Czochralski (MCz) grown ingots (1.1 Ωcm).

Results of the module testing with the three types of photovoltaic cells are shown in FIG. 6 in terms of percentage of power loss caused by exposure to natural outside light conditions in an accumulated dose of 50 kWh as measured using an accumulative pyrometer. The Gallium doped Cz-ingot had the least amount of decay, followed by the MCz. The control Cz-ingot shows the most decay. The Gallium ingot averages are within the measurement error of the testing tools. This LID-free combination of Gallium doped ingot, antimony doped glass and improved EVA formula constitutes a major improvement in product performance. Moreover, the improvements may add economic benefits since the improvements use materials of nearly identical costs to the traditional materials used.

A suitable dopant for silicon is an element of the third main group of the periodic table for producing p-type conductivity. However, it has been established that boron may enhance degradation effects of a silicon-based photovoltaic cell. Hence, preferably boron may be present in an amount of maximally 5×10¹⁴ boron atoms per cubic centimeter or completely avoided. Gallium and/or Indium are suitable dopants for providing p-type silicon.

Details on Czochralski growth of silicon and Magnetic-field-applied Czochralskli growth are available to the person skilled in the art, in the form of handbooks such as Fumio Shimura “Semiconductor Silicon Crystal Technology”, Academic Press (1989), sections 5.2.3 to 5.4.1, herein incorporated by reference.

The invention has been described using photovoltaic cells based on Czochralski-grown silicon. However, the photovoltaic cells may be formed of other materials, including those based on the following non-exhaustive list of silicon, chalcopyrite compounds, II-VI compounds, III-V compounds, organic materials, and dye-sensitized solar cells.

The term silicon is herein employed as a genus term that covers at least the following species: amorphous silicon, microcrystalline silicon, polycrystalline silicon, Czochralski-grown silicon, magnetic-field-applied Czochralski-grown silicon, float-zone silicon.

The term chalcopyrite compound is herein employed as a genus term that covers materials formed of a group I-III-VI semiconductor, including a p-type semiconductor of the copper indium diselenide (“CIS”) type. Special cases are sometimes also denoted as CIGS or CIGSS. It covers at least the following species: CuInSe₂; CuInₓGa₍₁₋ₓ₎Se₂; CuInₓGa₍₁₋ₓ₎Se_{y}S(_{2-y)}; CuInₓGa_{z}Al_{(1-x-z)}Se_{y}S_{(2-y)}, and combinations thereof; wherein 0 ≦x ≦1; 0 ≦x+z ≦1; and 0 ≦y ≦2. The chalcopyrite compound may further comprise a low concentration, trace, or a doping concentration of one or more further elements or compounds, in particular alkali such as sodium, potassium, rubidium, cesium, and/or francium, or alkali compounds. The concentration of such further constituents is typically 5 wt % or less, preferably 3 wt % or less.

The overall efficiency of a photovoltaic module may also be enhanced by employing an antimony-doped glass as the light-facing layer. FIG. 7 compares transmittance of cerium-free antimony-doped glass (line 31) with that of standard cerium-doped glass (line 32), both as produced. A difference spectrum has also been included in FIG. 7 (line 33). It is found that the antimony-doped glass has improved transmittance in the wavelength range of 300 to 400 nm. The UV cut-off wavelength turns out to be 30 nm lower in the antimony-doped glass.

1. A photovoltaic module comprising one or more photovoltaic cells packaged between a light-facing layer and a backside layer, wherein the light-facing layer comprises antimony-doped glass.

2. The photovoltaic module of claim 1, wherein the antimony-doped glass is formed of water-white glass.

3. The photovoltaic module of claim 2, wherein the water-white glass is tempered water-white glass.

4. The photovoltaic module of claim 1, wherein the transmittance of the light-facing layer is at least 90% over a wavelength range of 500 nm to 1100 nm.

5. The photovoltaic module of claim 1, wherein the transmittance of the light-facing layer is at least 90% over a wavelength range of 350 nm to 2500 nm as determined using Method A of ASTM-E424.

6. The photovoltaic module of claim 1, wherein the one or more photovoltaic cells are packaged in the form of a laminate.

7. The photovoltaic module of claim 1, wherein a layer comprising ethylene vinyl acetate is disposed between the light-facing layer and the one or more photovoltaic cells.

8. The photovoltaic module of claim 7, wherein the ethylene vinyl acetate layer has a transmittance of at least 91% over a spectrum comprising wavelengths ranging from 400 nm to 1100 nm in an 18 mil (0.46 mm) thick sheet after curing.

9. The photovoltaic module of claim 1, wherein the one or more photovoltaic cells are formed essentially of silicon.

10. The photovoltaic module of claim 9, wherein the silicon comprises a Czochralski-grown wafer.

11. The photovoltaic module of claim 10, wherein the Czochralski-grown wafer is a magnetic-field-applied Czochralski-grown wafer.

12. The photovoltaic module of claim 9, wherein the silicon is essentially p-type silicon.

13. The photovoltaic module of claim 9, wherein the silicon is doped with one or more elements comprised in the third main group of the periodic table for producing p-type conductivity, whereby boron may be present in an amount of maximally 5×10¹⁴ boron atoms per cubic centimeter.

14. The photovoltaic module of claim 9, wherein the silicon is essentially doped with a dopant selected from the group consisting of gallium and indium for producing p-type conductivity.

15. The photovoltaic module of claim 1, wherein the one or more photovoltaic cells are formed essentially of a thin-film photovoltaic structure on a substrate.

16. The photovoltaic module of claim 15, wherein the backside layer comprises the substrate.

17. The photovoltaic module of claim 15, wherein the thin-film photovoltaic structure comprises a chalcopyrite compound.

18. Use of an antimony-doped glass layer covering one or more photovoltaic cells in a photovoltaic module to reduce light-induced degradation of the photovoltaic module.
